(19) United States
(12) Patent Application Publication
(10) Pub. No.: US 2025/0272815 A1
(43) Pub. Date: Aug. 28, 2025

(54) IMAGE PROCESSING APPARATUS, METHOD, AND STORAGE MEDIUM

(71) Applicant: CANON KABUSHIKI KAISHA, Tokyo (JP)

(72) Inventor: KAZUHIRO NAMIKI, Kanagawa (JP)

(21) Appl. No.: 19/207,696

(22) Filed: May 14, 2025

Related U.S. Application Data
(63) Continuation of application No. PCT/JP2023/037363, filed on Oct. 16, 2023.

(30) Foreign Application Priority Data
Dec. 6, 2022 (JP) 2022-195015

(51) Int. Cl. G06T 7/00; G06F 3/01; G06T 3/40; G06T 5/70; G06T 7/50

(52) U.S. Cl. CPC G06T 7/0002; G06F 3/013; G06T 3/40; G06T 5/70; G06T 7/50

(57) ABSTRACT

An image processing apparatus includes a processor and a memory storing a program which causes the image processing apparatus to execute detecting a direction of a line of sight of a user viewing the display, detecting a first distance that is a distance relating to a depth to a position of a line of sight of the user, based on the detected direction of the line of sight, detecting a second distance that is a distance relating to a depth to a subject that exists in a direction of the user's line of sight, and changing, based on the first distance and the second distance, at least one of an area in which processing for changing image quality of the image is performed and an image quality in the processing for changing the image quality of the image.

### CROSS-REFERENCE TO RELATED APPLICATIONS

This application is a Continuation of International Patent Application No. PCT/JP2023/037363, filed Oct. 16, 2023, which claims the benefit of Japanese Patent Application No. 2022-195015, filed Dec. 6, 2022, both of which are hereby incorporated by reference herein in their entirety.

### BACKGROUND OF THE INVENTION

### Field of the Invention

The present invention relates to an image processing apparatus that performs rendering processing on a gaze point in a head-mounted display, a head-up display, or the like.

### Background Art

In recent years, attention has been focused on AR (Augmented Reality), which is a technology of displaying an image superimposed on a real-world scene in front of the user's eyes, and VR (Virtual Reality), which displays a real image different from the reality in front of the user's eyes. Some types of head-mounted displays (HMD) and vehicle head-up displays (HUDs) equipped with these techniques have a line-of-sight detection function. In the case where the line-of-sight detection function is installed, it is possible to assist the user to easily view a subject in the visual field in the display surface.

For example, a technique called foveated rendering is known that aims to further improve the sense of immersion, further reduce rendering costs, and further reduce transmission costs.

Patent Literature 1 proposes a technology that predicts the movement of the line of sight and performs high-resolution rendering processing on a region that includes not only the point of interest, but also the point to which the line of sight moves in time series.

### CITATION LIST

### Patent Literature

PTL1: Japanese Patent Laid-Open No. 2018-004950

However, in a real-world scene, the user may adopt an observation method of grasping an entire movement by viewing an object or scene in a surveying manner. In the surveying state, the user places a visual point further away from the subject such that the entire movement can be understood, even though it is not possible to recognize a fine shape or the like of the subject. In such a case, the line of sight of the user is not directed to the subject. Thus, with the technology described in Patent Literature 1, it is not possible to detect a specific region of interest when the user is surveying the scene.

The present invention has been made in view of the foregoing problem, and provides an image processing apparatus capable of performing appropriate rendering processing in accordance with the degree of surveying view of the user.

According to the present invention, there is provided an image processing apparatus that processes an image to be displayed on display, comprising: a processor; and a memory storing a program which, when executed by the processor, causes the image processing apparatus to execute: line-of-sight detection processing of detecting a direction of a line of sight of a user viewing the display; first distance detection processing of detecting a first distance that is a distance relating to a depth to a position of a line of sight of the user, based on the detected direction of the line of sight; second distance detection processing of detecting a second distance that is a distance relating to a depth to a subject that exists in a direction of the user's line of sight; and changing processing of changing, based on the first distance and the second distance, at least one of an area in which processing for changing image quality of the image is performed and an image quality in the processing for changing the image quality of the image.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1A is a diagram showing a schematic configuration of a head-mounted display that is a first embodiment of an image processing apparatus of the present invention.

FIG. 1B is a block diagram showing an internal configuration of the head-mounted display.

FIG. 2 is a diagram illustrating the principle of a line-of-sight detection method.

FIG. 3 is a diagram showing an image of an eyeball projected onto an eyeball image sensor and output intensity on the eyeball image sensor.

FIG. 4 is a flowchart showing a line-of-sight detection operation.

FIG. 5A is a diagram showing an example of how to obtain a convergence angle and a method of detecting a surveying degree.

FIG. 5B is a diagram showing an example of how to obtain a convergence angle and a method of detecting a surveying degree.

FIG. 5C is a diagram showing an example of how to obtain a convergence angle and a method of detecting a surveying degree.

FIG. 6 is a flowchart showing an operation of changing a blurring area based on the surveying degree.

FIG. 7A is a diagram showing an example of changing the blurring area based on the surveying degree.

FIG. 7B is a diagram showing an example of changing the blurring area based on the surveying degree.

FIG. 8 is a flowchart showing an operation of changing rendering image quality based on the surveying degree.

FIG. 9A is a diagram showing an example of changing the rendering image quality based on the surveying degree.

FIG. 9B is a diagram showing an example of changing the rendering image quality based on the surveying degree.

FIG. 10 is a flowchart showing an operation of changing the blurring area and the rendering image quality based on the surveying degree.

FIG. 11A is a diagram showing an example of changing the blurring area and the rendering image quality based on the surveying degree.

FIG. 11B is a diagram showing an example of changing the blurring area and the rendering image quality based on the surveying degree.

FIG. 12 is a flowchart showing an operation of changing the blurring area and the rendering image quality based on the surveying degree and a subject movement.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

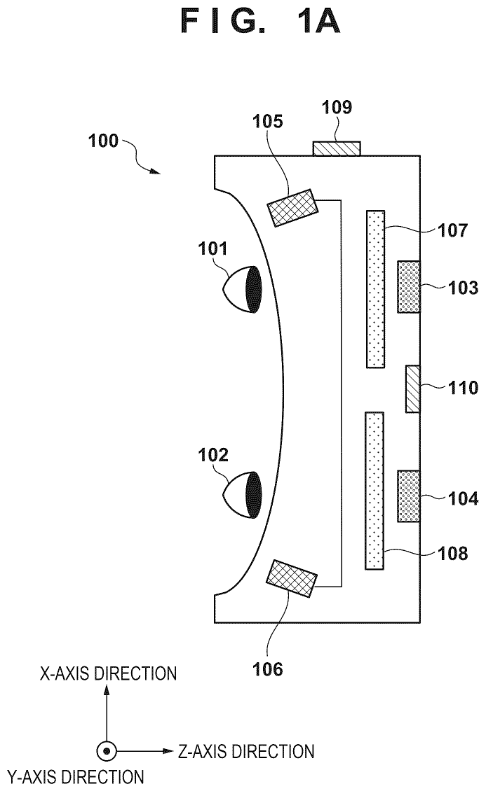

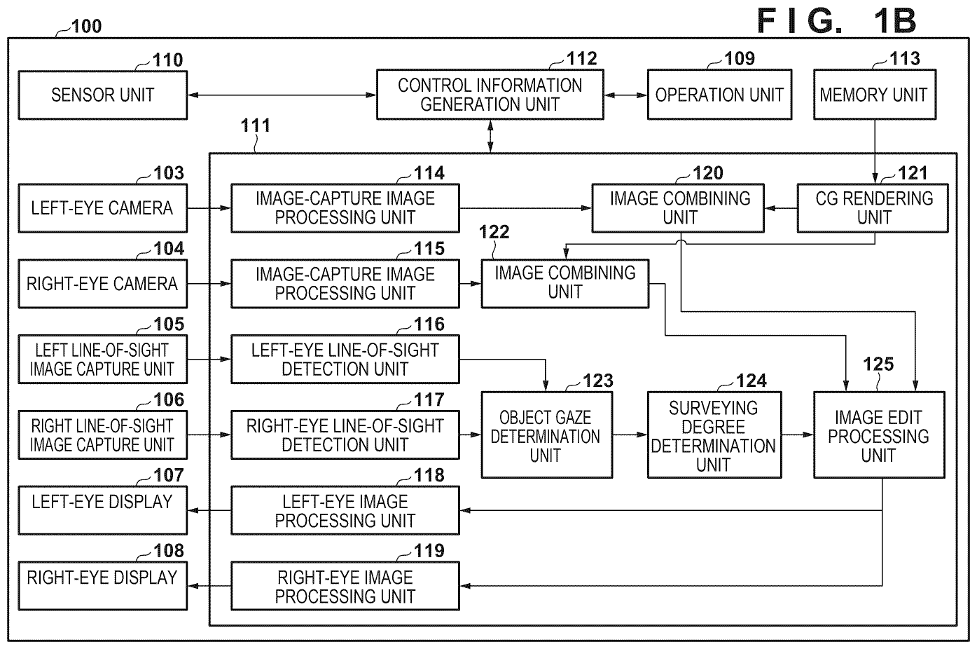

FIG. 1A is a diagram showing a schematic configuration of a head-mounted display (hereinafter, “HMD”) 100 that is the first embodiment of an image processing apparatus of the present invention. FIG. 1B shows a block configuration of the HMD 100.

In FIG. 1A, the left side of the figure shows a configuration of the HMD 100 viewed from the head top side of a user, and the right side shows a configuration of a line-of-sight detection device.

When the user wears the HMD 100 on their head, a left eye 101 and a right eye 102 can observe a real space through a left-eye display 107 and a right-eye display 108, respectively, which are of a see-through type. By displaying video of operation icons, image data, and the like on these see-through displays, the displayed video can be superimposed on the real world that the user is viewing through the display.

Another possible configuration is as follows. That is, non-see-through displays may be used to display video stored inside (captured moving image, game video etc.) when in a non-see-through mode, and to display images captured by a left-eye camera 103 and a right-eye camera 104 when in a see-through mode. Further, video that combines an internally stored video and images captured by the cameras may also be displayed.

Where on the display the user is gazing is estimated by a later-described line-of-sight detection operation using a left line-of-sight image capture unit 105 and a right line-of-sight image capture unit 106. The HMD 100 also includes an operation unit 109, to which functions such as a power button and various device operations can be assigned.

FIG. 1B shows a block diagram showing an internal configuration of the HMD 100. A sensor unit 110 detects the orientation of the HMD 100. A control unit 111 obtains image data, line-of-sight information, orientation information, and the like from the left-eye camera 103, the right-eye camera 104, the left line-of-sight image capture unit 105, the right line-of-sight image capture unit 106, and the sensor unit 110, and controls the entire HMD 100.

A control information generation unit 112 generates position/orientation information regarding the HMD 100 in a three-dimensional space based on images output from image-capture image processing units 114 and 115 and sensor information output from the sensor unit 110. The position/orientation information includes coordinates of the HMD 100 in a three-dimensional space, a line-of-sight direction of the user, a rotation angle of the HMD 100 relative to an axis in the line-of-sight direction, and the like. The sensor unit 110 detects information such as the direction and acceleration of the HMD 100 using, for example, a gyroscope. A memory unit 113 holds control information and virtual objects to be superimposed on a real-world scene by a CG rendering unit 121.

The image-capture image processing units 114 and 15 perform preset image processing on images input from the left-eye camera 103 and the right-eye camera 104. The image processing here includes gain correction, pixel defect correction, automatic exposure correction, distortion correction, and the like. Image combining units 120 and 122 receive images to be combined from the image-capture image processing units 114 and 115, and also receive CG information from the CG rendering unit 121. When frame information from the image-capture image processing unit 114 and 115 match, CG (Computer Graphics) from the CG rendering unit 121 is combined with the captured images, and the combined image is output to an image edit processing unit 125.

A left-eye line-of-sight detection unit 116 and a right-eye line-of-sight detection unit 117 detect the positions of the pupils of the user who is using the HMD 100, and supply line-of-sight information indicating which positions on the displays 107 and 108 the user is viewing as coordinate data to the image edit processing unit 125. An object gaze determination unit 123 calculates a gazing degree, which is the degree to which the user is gazing at an object, from line-of-sight vectors using a convergence angle obtained based on line-of-sight information regarding both eyes from the left-eye line-of-sight detection unit 116 and the right-eye line-of-sight detection unit 117. A surveying degree determination unit 124 determines whether or not the user is viewing a video in a surveying manner based on the convergence angle and the gazing degree that are results of determination by the object gaze determination unit 123.

The image edit processing unit 125 performs rendering processing in which, in the images from the image combining units 120 and 122, a region within a predetermined area centered on the line-of-sight direction of the user is not processed, and a region outside that area is blurred. That is, in the present embodiment, the rendering processing includes processing of changing image quality of the images. The blurring processing can be realized by, for example, filtering. In the present embodiment, processing of changing the rendering area and image quality is performed in accordance with the surveying degree of the user.

A left-eye image processing unit 118 and a right-eye image processing unit 119 perform control to display the images processed by the image edit processing unit 125 on the left-eye display 107 and the right-eye display 108. For example, the images are gamma corrected and thereafter displayed on the left-eye display 107 and the right-eye display 108.

### Description of Line-of-Sight Detection Operation

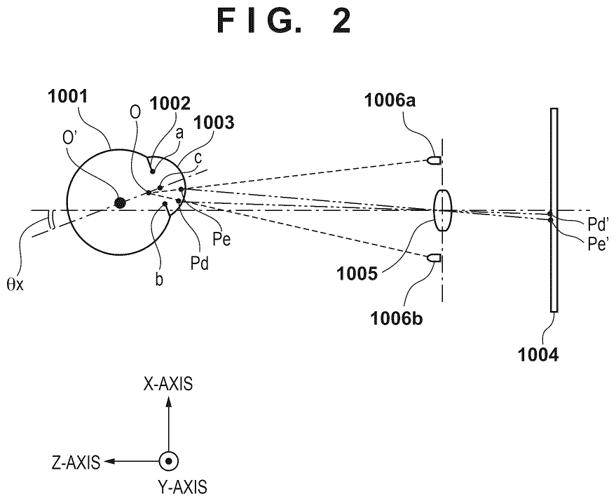

FIG. 2 is a diagram illustrating the principle of a line-of-sight detection method, and shows an optical system for performing processing of the aforementioned left-eye line-of-sight detection unit 116 and right-eye line-of-sight detection unit 117. In FIG. 2, light sources 1006a and 1006b are light sources such as light-emitting diodes or the like that emit infrared light imperceptible to the user. These light sources are substantially symmetrical with respect to an optical axis of a light-receiving lens 1005, and illuminate an eyeball 1001 of the user. A part of illumination light reflected by the eyeball 1001 is converged on an eyeball image sensor 1004 by the light-receiving lens 1005.

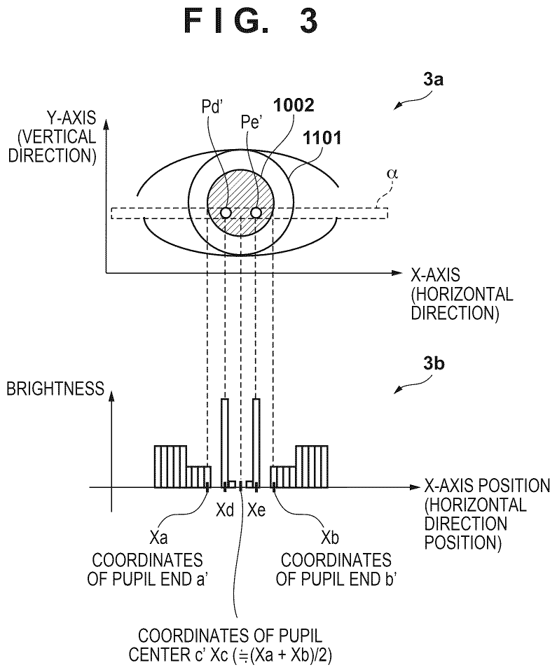

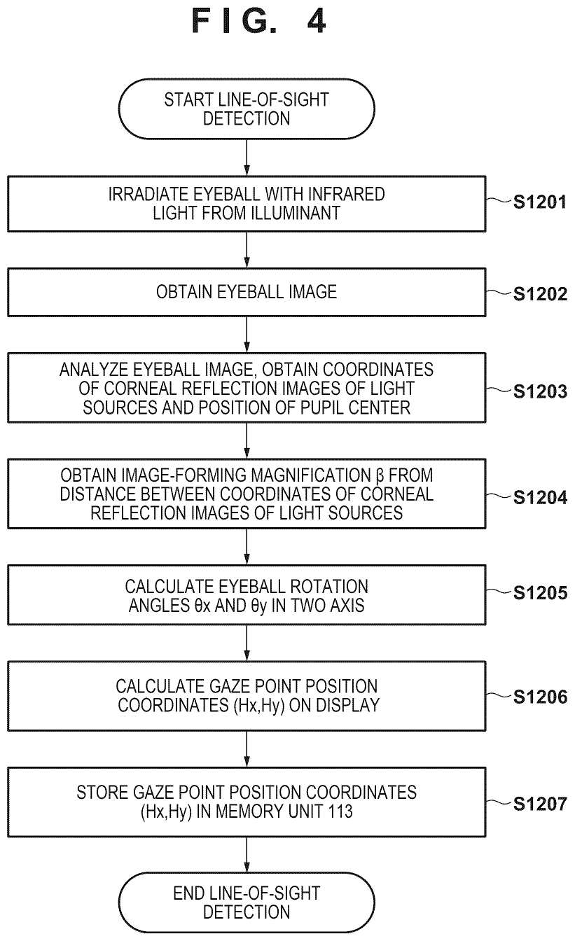

Reference numeral 3a in FIG. 3 denotes a schematic diagram of an eyeball image projected onto the eyeball image sensor 1004, and reference numeral 3b in FIG. 3 denotes a graph of output intensity on the eyeball image sensor 1004. FIG. 4 is a flowchart showing an operation of line-of-sight detection.

When a line-of-sight detection routine is started in FIG. 4, in step S1201, the control unit 111 turns on the light sources 1006a and 1006b and irradiates the eyeball 1001 of an observer with infrared light. The eyeball image of the observer illuminated by the infrared light is formed on the eyeball image sensor 1004 through the light-receiving lens 1005.

In step S1202, the control unit 111 causes the eyeball image sensor 1004 to perform photoelectric conversion on the formed eyeball image and obtains an image signal of the eyeball.

In step S1203, the control unit 111 obtains the coordinates of points corresponding to corneal reflection images Pd and Pe of the light sources 1006a and 1006b and a pupil center c shown in FIG. 2 from the eyeball image signal obtained in step S1202.

The infrared light emitted from the light sources 1006a and 1006b illuminates a cornea 1003 of the eyeball 1001 of the observer. At this time, the corneal reflection images Pd and Pe formed by a part of the infrared light reflected off the surface of the cornea 1003 are converged by the light-receiving lens 1005 and formed on the eyeball image sensor 1004 (points Pd′ and Pe′ in the figure). Similarly, light beams from ends a and b of the pupil 1002 also form images on the eyeball image sensor 1004.

Reference numeral 3a in FIG. 3 denotes an example image of a reflected image obtained from the eyeball image sensor 1004. Reference numeral 3b in FIG. 3 denotes example brightness information regarding a region a in 3a in FIG. 3 obtained from the eyeball image sensor 1004.

As shown in FIG. 3, the X-axis indicates the horizontal direction, and the Y-axis indicates the vertical direction. Here, Xd and Xe denote the coordinates in the X-axis direction (horizontal direction) of the images Pd′ and Pe′, respectively, formed by the light beams from the corneal reflection images of the light sources 1006a and 1006b. Xa and Xb denote the coordinates in the X-axis direction of the images a′ and b′, respectively, formed by the light beams from the ends a and b of the pupil 1002.

In the example brightness information denoted by 3b in FIG. 3, an extremely strong level of brightness is obtained at the positions Xd and Xe corresponding to the images Pd′ and Pe′ formed by the light beams from the corneal reflection images of the light sources 1006a and 1006b. An extremely low level of brightness is obtained in a region between the coordinates Xa and Xb, which corresponds to the region of the pupil 1002, except for the aforementioned positions of Xd and Xe. Meanwhile, intermediate values between the aforementioned two brightness levels are obtained in regions with X-coordinate values smaller than Xa and regions with X-coordinate values larger than Xb, which correspond to the region of an iris 1101 outside the pupil 1002.

Based on the information on the variation in the brightness level with respect to the X-coordinate position, the X-coordinates Xd and Xe of the images Pd′ and Pe′ formed by the light beams from the corneal reflection images of the light sources 1006a and 1006b, and the X-coordinates Xa and Xb of the images a′ and b′ at the pupil ends can be obtained. Further, when a rotation angle θx of the optical axis of the eyeball 1001 relative to the optical axis of the light-receiving lens 1005 is small, the coordinate Xc of a spot (denoted as c′) corresponding to the pupil center c whose image is formed on the eyeball image sensor 1004 can be represented as Xc≈(Xa+Xb)/2. From these, it is possible to estimate the X-coordinate of c′, which corresponds to the pupil center whose image is formed on the eyeball image sensor 1004, and the coordinates of the images Pd′ and Pe′, which correspond to the corneal reflection images of light sources 1006a and 1006b.

Returning to the description of FIG. 4, in step S1204, the control unit 111 calculates an image-forming magnification β of the eyeball image. β denotes a magnification determined by the position of the eyeball 1001 relative to the light-receiving lens 1005, and can be obtained substantially as a function of the spacing (Xd-Xe) between the corneal reflection images Pd′ and Pe′.

In step S1205, the control unit 111 calculates rotation angles Ox and Oy in two axis directions of the optical axis of the eyeball 1001. The X-coordinate of a middle point between the corneal reflection images Pd and Pe and the X-coordinate of a curvature center O of the cornea 1003 substantially coincide with each other. Thus, when Oc denotes a standard distance from the curvature center O of the cornea 1003 to the center c of the pupil 1002, the rotation angle θx of the optical axis of the eyeball 1001 in the Z-X plane can be obtained from the following relational expression:

$$β * Oc * sin θ x \approx \{ ( X d + Xe ) / 2 \} - X c \qquad ( 1 )$$

Although FIGS. 2 and 3 illustrate an example of calculating the rotation angle θx when the observer's eyeball rotates in a plane perpendicular to the Y-axis, the same applies to the method of calculating the rotation angle θy when the observer's eyeball rotates in a plane perpendicular to the X-axis.

In step S1206, the control unit 111 determines the positions of the lines of sight of the observer (the positions of the points at which the observer is gazing: hereinafter referred to as “gaze points”) on the left-eye display 107 and the right-eye display 108, using θx and θy calculated in step S1205. Assuming that the coordinates of the positions of the gaze points are (Hx, Hy), which correspond to the center c of the pupil 1002 on the left-eye display 107 and the right-eye display 108, Hx and Hy can be calculated as follows:

$$H x = m \times ( A x \times θ x + Bx ) \qquad ( 2 )$$

$$Hy = m \times ( A y \times θ y + By ) \qquad ( 3 )$$

Here, the coefficient m is a constant determined by the configuration of the optical system, and is a conversion coefficient for converting the rotation angles θx and θy to the position coordinates corresponding to the center c of the pupil 1002 on the left-eye display 107 and the right-eye display 108. Further, it is assumed that the value of the coefficient m is predetermined and stored in the memory unit 113.

Ax, Bx, Ay, and By are line-of-sight correction coefficients for correcting individual differences in the lines of sight of the observer, and are obtained by performing a calibration operation. It is assumed that these coefficients are stored in the memory unit 113 before the line-of-sight detection routine is started.

After calculating the coordinates (Hx, Hy) of the center c of the pupil 1002 on the left-eye display 107 and the right-eye display 108 as described above, the control unit 111 stores the above coordinates in the memory unit 113 in step S1207, and ends the line-of-sight detection routine.

The above-described method of acquiring the gaze point coordinates on the left-eye display 107 and the right-eye display 108 uses the corneal reflection images of the light sources 1006a and 1006b. However, the line-of-sight detection method is not limited to the above method, and any other method may be used as long as the eyeball rotation angle can be obtained from a captured eyeball image.

### Surveying Degree Calculation and Change of Blurring Area

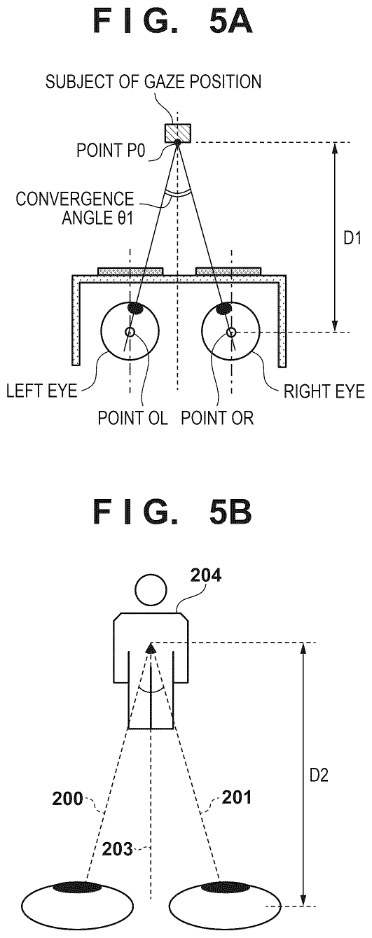

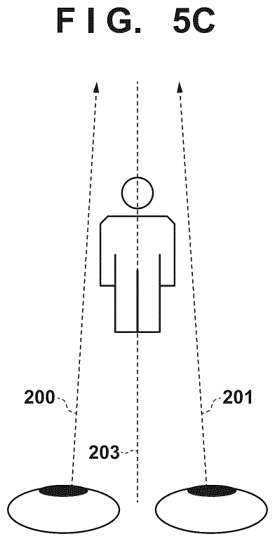

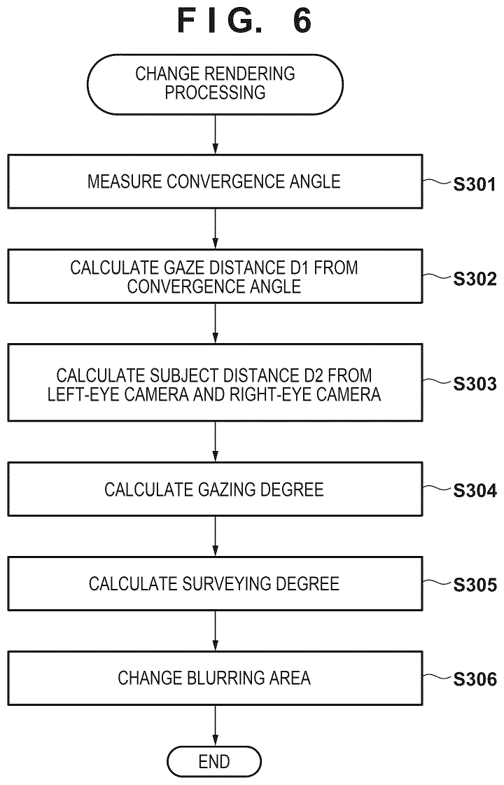

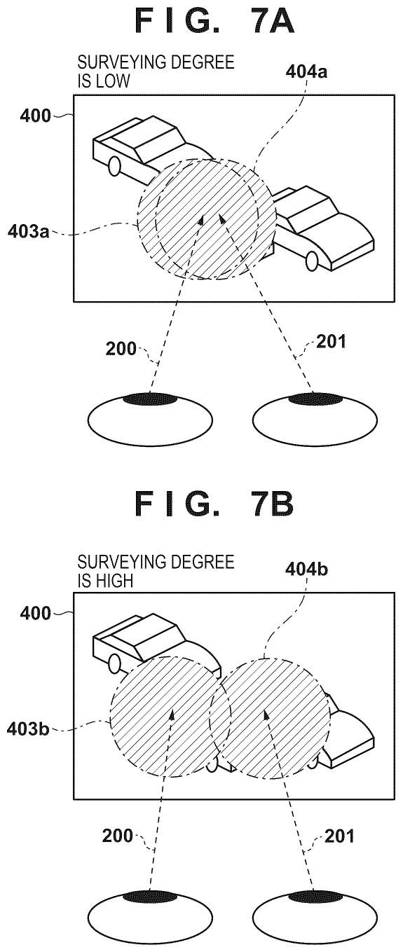

The calculation of the surveying degree and the change of a blurring area will be described with reference to FIGS. 5A to 5C, 6, 7A, and 7B. FIGS. 5A to 5C are diagrams showing an example of a method of detecting the convergence angle and a method of calculating the surveying degree. FIG. 6 is a flowchart showing an example of changing the blurring area based on the surveying degree. FIG. 7 show an example of processing for changing the area of rendering processing (blurring area) for a video based on a surveying degree determination result.

In step S301 in FIG. 6, the control unit 111 calculates a convergence angle of the eyes. The “convergence angle” refers to an angle formed by the lines of sight of the two eyes when viewing a point P0, as represented by θ1 in FIG. 5A. The convergence angle θ1 decreases as the distance to the point P0 increases, and conversely, the convergence angle θ1 increases as the distance to the point P0 decreases. The convergence angle can be calculated by obtaining an intersection of straight lines in the directions toward the gaze point position of the respective eyes.

In this embodiment, for example, the left-eye line-of-sight detection unit 116 and the right-eye line-of-sight detection unit 117 in FIG. 1B calculate line-of-sight vectors 200 and 201 of the respective eyes in FIGS. 5B and 5C, which are input to the object gaze determination unit 123. The object gaze determination unit 123 obtains the convergence angle from the line-of-sight vectors of the respective eyes.

In step S302, the control unit 111 calculates a distance D1 to the gaze position using the convergence angle obtained in step S301 and the spacing between the two eyes (from a point OL to a point OR) (first distance detection). This can be obtained using a trigonometric function. Alternatively, a method may be applied in which the correlation between a plurality of subjects at different distances and convergence angles when viewing these subjects is measured and stored in advance, and the distance to a subject is estimated from the convergence angle based on the correlation.

In step S303, the control unit 111 calculates a subject distance D2 based on information obtained from the left-eye camera 103 and the right-eye camera 104 (second distance detection). The subject distance D2 to a subject present on a straight line 203 between the line-of-sight vectors 200 and 201 of the respective eyes in FIGS. 5B and 5C is performed using, for example, depth information obtained from the left-eye camera 103 and the right-eye camera 104. More specifically, an in-focus position of a focus lens is calculated using an auto-focus function (phase difference detection function) of the left-eye camera 103 and the right-eye camera 104, and the subject distance is calculated from the position of the focus lens in focus and parameters of the optical system. However, the method of calculating the subject distance D2 is not limited to this method, and any method, such as a distance calculation method using LiDAR, may be used if the distance from the HMD 100 to the subject can be obtained.

In step S304, the control unit 111 calculates a gazing degree for determining whether or not the user is gazing at the subject. A ratio between the gaze distance D1 obtained in step S302 and the subject distance D2 obtained in step S303 is obtained, and the gazing degree is calculated by obtaining a degree of deviation between the gaze distance and the subject distance. The gazing degree is calculated, for example, as a ratio (D1/D2) between the gaze distance D1 and the subject distance D2. However, the method of calculating the gazing degree is not limited thereto, and the gazing degree may alternatively be expressed using a difference between the gaze distance D1 and the subject distance D2.

Based on the calculated gazing degree, the object gaze determination unit 123 determines that the user is gazing less at the subject as the ratio between the gaze distance D1 and the subject distance D2 deviates further from 1, and determines that the user is gazing more at the subject as the ratio approaches 1. Note that if the gazing degree (D1/D2) is greater than 1, the user is viewing something farther away than the subject, and the convergence angle θ1 takes a small value. If the gazing degree (D1/D2) is smaller than 1, the user is viewing something closer than the subject, and the convergence angle θ1 takes a large value. In either case, it is determined that the user is not gazing at the subject.

In step S305, the control unit 111 uses the surveying degree determination unit 124 to calculate a surveying degree indicating whether or not the user is viewing the subject in a surveying manner, based on the gazing degree for the subject obtained in step S304. It is determined that the surveying degree is higher as the gazing degree obtained in step S304 deviates from 1, and that the surveying degree is lower as the gazing degree approaches 1. Specifically, the surveying degree is obtained by, for example, an equation: surveying degree=gazing degree (D1/D2)−1, and the surveying degree is determined to be higher as the absolute value of the value obtained by this equation is larger. Further, if the surveying degree (D1/D2)−1 takes a positive value, it indicates that the user is viewing something farther away than the subject, and if the surveying degree takes a negative value, it indicates that the user is viewing something closer than the subject. However, the method of calculating the surveying degree is not limited thereto, and the surveying degree may alternatively be expressed using, for example, an inverse number of the gazing degree (D1/D2).

In step S306, the blurring area in image rendering is changed based on the surveying degree obtained in step S305. For example, FIG. 7A is a diagram showing a setting of the blurring area when it is determined that the surveying degree is lower than a predetermined threshold. When the surveying degree is low, the convergence angle formed by the line-of-sight vectors 200 and 201 of the eyes is large, so that the gaze positions of the respective eyes in the left line-of-sight image capture unit 105 and the right line-of-sight image capture unit 106 are close to each other. That is, the user is viewing an area near the gaze positions in an image 400, and the image quality at this portion needs to be high. Thus, the blurring area when the surveying degree is low is, for example, an area outside circles 403a and 404a in a fixed area centered on the gaze positions of the respective eyes (i.e., a peripheral region of the image), as shown in FIG. 7A. Note that the image within the circles 403a and 404a is not edited, and high image quality is maintained.

FIG. 7B is a diagram showing a setting of the blurring area when it is determined that the surveying degree is greater than or equal to the predetermined threshold. When it is determined that the surveying degree is high, particularly when the user is viewing something farther away than the subject, the convergence angle formed by the line-of-sight vectors 200 and 201 of the eyes is small, so that the gaze positions of the respective eyes in the left line-of-sight image capture unit 105 and the right line-of-sight image capture unit 106 are separated from each other. That is, the user is viewing a relatively wide area near the gaze positions in the image 400, and the image quality at this portion needs to be high. Thus, the blurring area when the surveying degree is high is, for example, an area outside circles 403b and 404b centered on the gaze positions of the respective eyes (i.e., a peripheral region of the image), as shown in FIG. 7B.

Note that, in the above description, the blurring area is an area outside the circles centered on the gaze positions. However, the blurring area is not limited thereto, and may be, for example, an area outside a rectangular region including the gaze positions. Also, in the above description, the size of the blurring area is changed gradually in accordance with the surveying degree. However, the size of the blurring area may alternatively be changed continuously in accordance with the change in the surveying degree.

Thus, it is determined whether or not the user is viewing the video in a surveying manner, and the rendering area is changed in accordance with the determined surveying degree. With this, if the surveying degree is high (the gazing degree is low), rendering can be performed while setting the area size of the blurring area in the image to a relatively narrow area in the peripheral region of the image (i.e., setting a relatively wide area including the gaze positions as a high-image-quality area). If the surveying degree is low (the gazing degree is high), rendering can be performed while setting the area size of the blurring area in the image to a relatively wide area in the peripheral region of the image (i.e., setting a relatively narrow area including the gaze positions as a high-image-quality area). This makes it possible to provide a viewing environment in which an appropriate area of the high-image-quality region is set in accordance with the surveying degree of the user.

### Second Embodiment

The second embodiment of the present invention will be described below. The image processing apparatus in the second embodiment has the same configuration as that of the head-mounted display (hereinafter, “HMD”) 100 shown in FIGS. 1A and 1B in the first embodiment, and the description thereof is omitted accordingly.

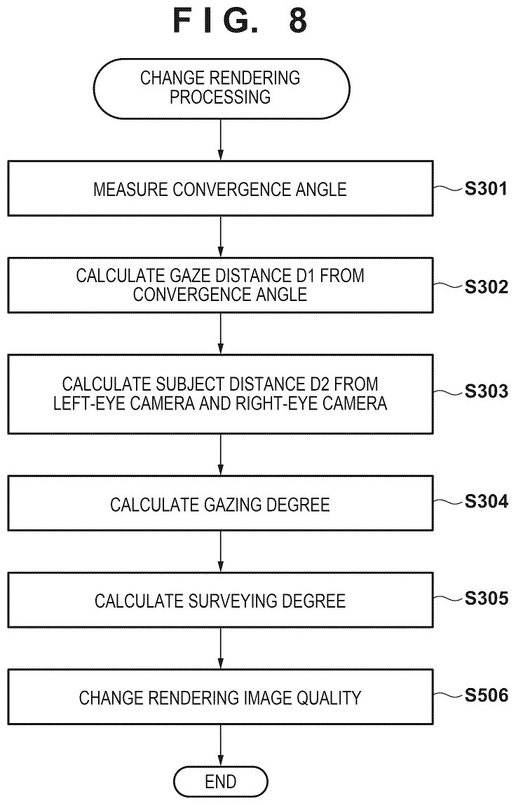

In this embodiment, an example of changing rendering image quality in accordance with the surveying degree will be described. FIG. 8 is a flowchart showing an example of changing the rendering image quality in accordance with the surveying degree. Since the processing in FIG. 8 has many parts in common with FIG. 6 illustrating the first embodiment, the steps of performing the same processing as in FIG. 6 are assigned the same step numbers as in FIG. 6, and the description thereof is omitted.

In FIG. 8, processing in steps S301 to S305 is the same as the processing in steps S301 to S305 in FIG. 6.

In step S506, the control unit 111 changes image quality in image rendering based on the surveying degree obtained in step S305.

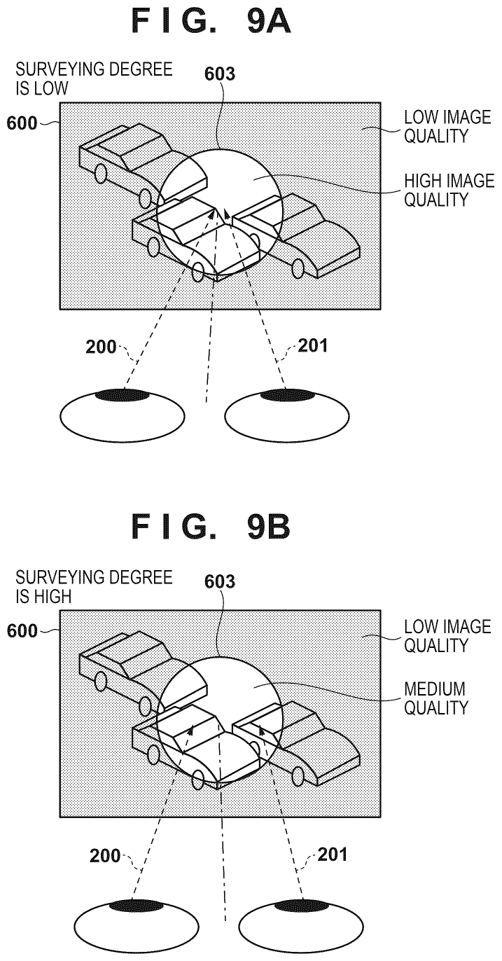

FIGS. 9A and 9B show an example of changing rendering image quality based on the surveying degree.

For example, if it is determined that the surveying degree is lower than the predetermined threshold, i.e., if the user is gazing at the subject as shown in FIG. 9A, rendering processing is performed such that the image quality in a rendering area 603 in an image 600 is high, i.e., an image quality higher than a predetermined image quality. The other area is subjected to rendering processing with low image quality, i.e., an image quality lower than a predetermined image quality.

The image quality described here refers to, for example, the resolution. In a high image quality area, rendering is performed to obtain a detailed image with a resolution higher than a predetermined level, and in a low image quality area, rendering processing is performed with a resolution lower than the predetermined level.

If the surveying degree is greater than or equal to the predetermined threshold, i.e., if the user is not gazing at a specific subject but viewing the scene in a surveying manner to some extent as shown in FIG. 9B, rendering processing is performed while setting the image quality in the rendering area 603 to a medium image quality. The other area is subjected to rendering processing at low image quality that is an image quality lower than a predetermined image quality. The “medium image quality” here refers to a resolution higher than the image quality outside the rendering area and lower than in the case of not performing rendering (i.e., not editing the image).

Note that, in FIG. 9B, the rendering area when the surveying degree is greater than or equal to the predetermined threshold is depicted as the same rendering area as in the case shown in FIG. 9A where the surveying degree is lower than the predetermined level.

As described above, in the present embodiment, it is determined whether or not the user is viewing a video in a surveying manner. If the surveying degree is high, the resolution, which is the rendering image quality, is set low, and if the surveying degree is low, the resolution is set high. This makes it possible to provide appropriate image quality to the user in accordance with the surveying degree.

### Third Embodiment

The third embodiment of the present invention will be described below. The image processing apparatus in the third embodiment has the same configuration as that of the head-mounted display (hereinafter, “HMD”) 100 shown in FIGS. 1A and 1B in the first embodiment, and the description thereof is omitted accordingly.

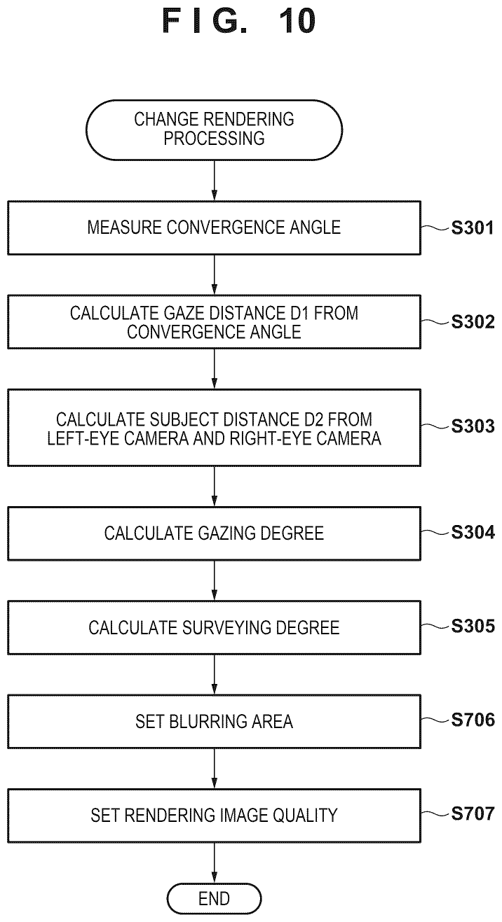

In this embodiment, an example of changing the blurring area and rendering image quality in accordance with the surveying degree will be described. FIG. 10 is a flowchart showing an example of changing the blurring area and rendering image quality in accordance with the surveying degree. Since the processing in FIG. 10 has many parts in common with FIG. 6 illustrating the first embodiment, the steps of performing the same processing as in FIG. 6 are assigned the same step numbers as in FIG. 6, and the description thereof is omitted.

In FIG. 10, processing in steps S301 to S305 is the same as the processing in steps S301 to S305 in FIG. 6.

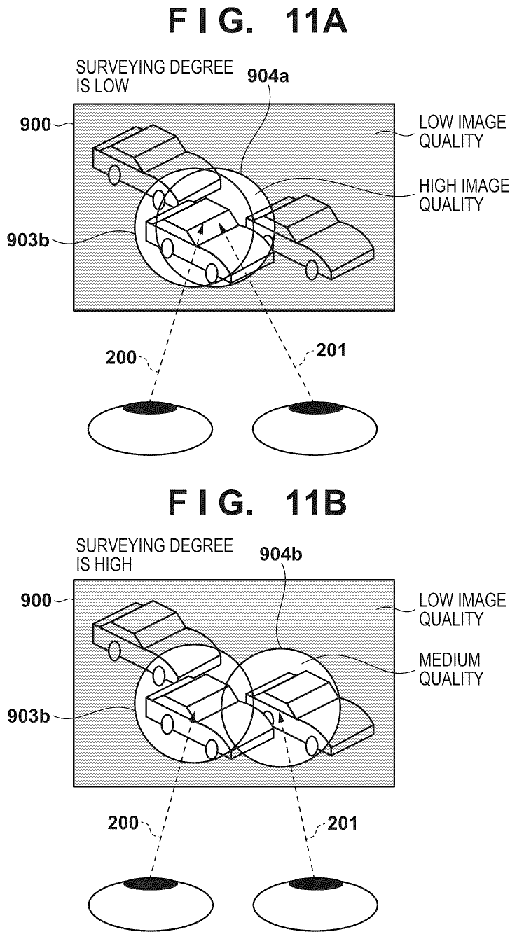

In step S706, the control unit 111 changes the blurring area in image rendering based on the surveying degree obtained in step S305, as in step S306 in FIG. 6. For example, FIG. 11A is a diagram showing a setting of the blurring area when it is determined that the surveying degree is lower than a predetermined threshold. When the surveying degree is low, the convergence angle formed by the line-of-sight vectors 200 and 201 of the eyes is large, so that the gaze positions of the respective eyes in the left line-of-sight image capture unit 105 and the right line-of-sight image capture unit 106 are close to each other. That is, the user is viewing an area near the gaze positions in an image 900, and the image quality at this portion needs to be high. Thus, the blurring area when the surveying degree is low is, for example, an area outside circles 903a and 904a in a fixed area centered on the gaze positions of the respective eyes, as shown in FIG. 11A.

FIG. 11B is a diagram showing a setting of the blurring area when it is determined that the surveying degree is greater than or equal to the predetermined threshold. When it is determined that the surveying degree is high, particularly when the user is viewing something farther away than the subject, the convergence angle formed by the line-of-sight vectors 200 and 201 of the eyes is small, so that the gaze positions of the respective eyes in the left line-of-sight image capture unit 105 and the right line-of-sight image capture unit 106 are separated from each other. That is, the user is viewing a relatively wide area near the gaze positions in the image 900, and the image quality at this portion needs to be high. Thus, the blurring area when the surveying degree is high is, for example, an area outside circles 903b and 904b centered on the gaze positions of the respective eyes, as shown in FIG. 11B. Note that, in the above description, the blurring area is an area outside the circles centered on the gaze positions. However, the blurring area is not limited thereto, and may be, for example, an area outside a rectangular region including the gaze positions.

In step S707, the control unit 111 changes the image quality in image rendering based on the surveying degree obtained in step S305, as in step S506 in FIG. 8.

For example, if it is determined that the surveying degree is lower than the predetermined threshold, i.e., if the user is gazing at the subject as shown in FIG. 11A, rendering processing is performed such that the image quality in rendering areas 903a and 903b in the image 900 is high, i.e., an image quality higher than a predetermined image quality. The other area is subjected to rendering processing with low image quality, i.e., an image quality lower than a predetermined image quality.

The image quality described here refers to, for example, the resolution. In a high image quality area, rendering is performed to obtain a detailed image with a resolution higher than a predetermined level, and in a low image quality area, rendering processing is performed with a resolution lower than the predetermined level.

If the surveying degree is greater than or equal to the predetermined threshold, i.e., if the user is not gazing at a specific subject but viewing the scene in a surveying manner to some extent as shown in FIG. 11B, rendering processing is performed while setting the image quality in the rendering areas 903b and 904b to medium image quality. The other area is subjected to rendering processing at low image quality that is an image quality lower than a predetermined image quality. The “medium image quality” here refers to a resolution higher than the image quality outside the rendering area and lower than in the case of not performing rendering (i.e., not editing the image).

As described above, in the present embodiment, it is determined whether or not the user is viewing a video in a surveying manner. If the surveying degree is high, the area size of the blurring area in a peripheral region of the image is set narrow, and the resolution (resolution in the vicinity of the gaze points), which is the rendering image quality, is set low. If the surveying degree is low, the area size of the blurring area in a peripheral region of the image is set wide, and the resolution (resolution in the vicinity of the gaze points), which is the rendering image quality, is set high. This makes it possible to provide an appropriate blurring area and appropriate image quality to the user in accordance with the surveying degree.

Note that, in the above description, the size of the blurring area and the resolution, which is the rendering image quality, are changed gradually in accordance with the surveying degree. However, they may alternatively be changed continuously in accordance with the change in the surveying degree.

In FIG. 10, the blurring area obtained in step S706 and the rendering image quality obtained in step S707 are set based only on the surveying degree of the user. However, they may also be changed based on the movement of the subject.

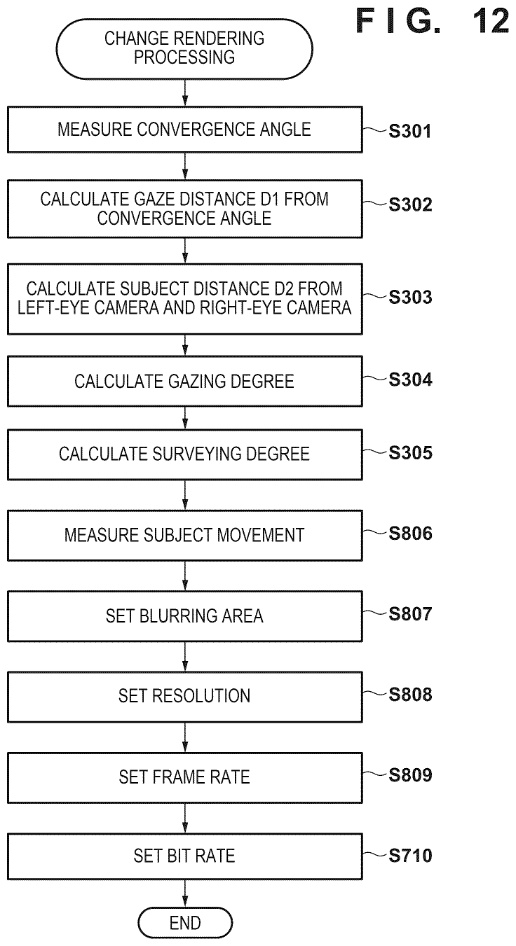

FIG. 12 is a flowchart showing an example of changing the blurring area and rendering image quality while considering the subject movement.

In FIG. 12 as well, processing in steps S301 to S305 is the same as the processing in steps S301 to S305 in FIG. 6.

In step S806, the control unit 111 measures the movement of the subject. For example, the speed of movement of the subject is measured on each display from a moving distance on the image plane of the subject and the movement of the HMD 100.

In step S807, the control unit 111 sets a blurring area based on the surveying degree obtained in step S305 and the movement of the subject obtained in step S806. For example, even if the surveying degree is lower than or equal to a predetermined level, if the speed of movement of the subject is higher than a predetermined level, the radius of the high-image-quality rendering area centered on the line-of-sight vectors of the respective eyes is expanded. Also, even if the surveying degree is higher than the predetermined level, if the speed of movement of the subject is lower than or equal to the predetermined level, the radius of the rendering area centered on the line-of-sight vectors of the respective eyes is set to be narrow.

In step S808, the control unit 111 sets a resolution based on the movement of the subject obtained in step S806. For example, even if the surveying degree of the user is higher than a predetermined level, if the speed of movement of the subject is higher than a predetermined level, the resolution in the rendering areas 903b and 904b in FIG. 11B is set to a medium resolution. If the speed of movement of the subject is lower than or equal to the predetermined level, the resolution in the rendering areas 903b and 904b is set to a high resolution.

In step S809, the control unit 111 sets a frame rate based on the movement of the subject obtained in step S806. Even when the surveying degree of the user is high, if the speed of movement of the subject is higher than a predetermined level, the frame rate is set higher than a predetermined level, and if the speed of movement of the subject is lower than or equal to the predetermined level, the frame rate is set lower than or equal to the predetermined level. Rendering processing is performed at the frame rate thus set.

In step S810, a bit rate is set based on the movement of the subject obtained in step S806. Even when the surveying degree of the user is higher than a predetermined level, if the speed of movement of the subject is higher than a predetermined level, the bit rate is set higher than a predetermined level, and if the speed of movement of the subject is lower than or equal to the predetermined level, the bit rate is set lower than or equal to the predetermined level. Rendering processing is performed with the bit rate thus set.

If the surveying degree is high, the details of the subject cannot be recognized, and thus the resolution is set lower than a predetermined rendering resolution. Meanwhile, if a fast-moving subject is present, a video with a visual sense of presence is displayed so as to present smoother and more natural movement.

Even if the surveying degree is high, it is not necessary to present smooth movement in a scene with less movement. Instead, the resolution is increased to provide a fine video.

As described above, in FIG. 12, the blurring area and the rendering image quality are changed based on the movement of the subject. However, the rendering area and the rendering image quality may be changed not only based on the movement of the subject, but also based on the location, brightness, or other aspects of the shooting scene.

For the rendering image quality, the resolution, frame rate, and bit rate are changed, but the items to be changed are not limited thereto. For example, in a dark place, the dynamic range may also be widened to widen the band of brightness information and improve the reproducibility of light and shade and color tones.

According to the present invention, appropriate rendering processing can be performed in accordance with the degree of surveying view of the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image processing apparatus that processes an image to be displayed on display, comprising:
a processor; and
a memory storing a program which, when executed by the processor, causes the image processing apparatus to execute:
line-of-sight detection processing of detecting a direction of a line of sight of a user viewing the display;
first distance detection processing of detecting a first distance that is a distance relating to a depth to a position of a line of sight of the user, based on the detected direction of the line of sight;
second distance detection processing of detecting a second distance that is a distance relating to a depth to a subject that exists in a direction of the user's line of sight; and
changing processing of changing, based on the first distance and the second distance, at least one of an area in which processing for changing image quality of the image is performed and an image quality in the processing for changing the image quality of the image.

2. The image processing apparatus according to claim 1, wherein the processing for changing the image quality is processing for blurring a peripheral region of the image.

3. The image processing apparatus according to claim 2, wherein the processor further causes the image processing apparatus to execute obtaining processing of obtaining a surveying degree indicating a degree to which the user is viewing the subject in a surveying manner, based on the first distance and the second distance, and wherein the changing processing reduces an area size of the peripheral region of the image for which the blurring processing is performed, as the surveying degree increases.

4. The image processing apparatus according to claim 1, wherein the processing for changing the image quality is processing for making image quality of the image near a visual point of the user higher than the image quality in the peripheral region of the image.

5. The image processing apparatus according to claim 4, wherein the processor further causes the image processing apparatus to execute obtaining processing of obtaining a surveying degree indicating a degree to which the user is viewing the subject in a surveying manner, based on the first distance and the second distance, and wherein the changing processing lowers the image quality of the image in a region where the image quality of the image is increased, as the surveying degree increases.

6. The image processing apparatus according to claim 4, wherein the image quality of the image is a resolution of the image.

7. The image processing apparatus according to claim 1, wherein the processing for changing the image quality is processing for blurring a peripheral region of the image and increasing the image quality of the image near a visual point of the user.

8. The image processing apparatus according to claim 7, wherein the processor further causes the image processing apparatus to execute obtaining processing of obtaining a surveying degree indicating a degree to which the user is viewing the subject in a surveying manner, based on the first distance and the second distance, and wherein as the surveying degree increases, the changing processing decreases an area size of the peripheral region of the image to be subjected to the processing for blurring the image, and decreases the image quality of the image in a region where the image quality of the image is increased.

9. The image processing apparatus according to claim 1, wherein the changing processing changes an area in which the processing for changing the image quality is performed, based on a shooting scene.

10. The image processing apparatus according to claim 1, wherein the changing processing changes the image quality in the processing for changing the image quality, based on a shooting scene.

11. The image processing apparatus according to claim 10, wherein the changing processing changes a bit rate, a frame rate, and a dynamic range of the image, based on the shooting scene.

12. The image processing apparatus according to claim 1, wherein the processor further causes the image processing apparatus to execute obtaining processing of obtaining a surveying degree indicating a degree to which the user is viewing the subject in a surveying manner, based on the first distance and the second distance, and wherein the obtaining processing obtains a gazing degree indicating a degree to which the user is gazing at the subject, based on a ratio between the first distance and the second distance.

13. The image processing apparatus according to claim 12, wherein the obtaining processing obtains the surveying degree based on the gazing degree.

14. The image processing apparatus according to claim 1, wherein the first distance detection processing detects the first distance based on a convergence angle of the user.

15. An image processing method of processing an image to be displayed on display, the method comprising:
detecting a direction of a line of sight of a user viewing the display;
detecting a first distance that is a distance relating to a depth to a position of a line of sight of the user, based on the detected direction of the line of sight;
detecting a second distance that is a distance relating to a depth to a subject that exists in a direction of the user's line of sight; and
changing, based on the first distance and the second distance, at least one of an area in which processing for changing image quality of the image is performed and an image quality in the processing for changing the image quality of the image.

16. A non-transitory computer-readable storage medium in which a program for causing a computer to execute each step of an image processing method of processing an image to be displayed on display, the method comprising:
detecting a direction of a line of sight of a user viewing the display;
detecting a first distance that is a distance relating to a depth to a position of a line of sight of the user, based on the detected direction of the line of sight;
detecting a second distance that is a distance relating to a depth to a subject that exists in a direction of the user's line of sight; and
changing, based on the first distance and the second distance, at least one of an area in which processing for changing image quality of the image is performed and an image quality in the processing for changing the image quality of the image.
